(19) United States
(12) Patent Application Publication
(10) Pub. No.: US 2018/0151291 A1
(43) Pub. Date: May 31, 2018

(54) INDUCTOR WITH EMBEDDED DIODE

(71) Applicant: QUALCOMM Incorporated, San Diego, CA (US)

(72) Inventors: Sandeep Chaman DHAR, San Diego, CA (US); Zhen Ning LOW, San Diego, CA (US)

(21) Appl. No.: 15/708,077

(22) Filed: Sep. 18, 2017

Related U.S. Application Data
(60) Provisional application No. 62/427,781, filed on Nov. 29, 2016.

(51) Int. Cl. H01F 27/40; H01F 27/42

(52) U.S. Cl. CPC H01F 27/40; H01F 27/42

(57) ABSTRACT

Some examples of the disclosure include a low profile inductor for use on a printed circuit board to minimize the area occupied and enable easier breakout routing and opening up additional area for other components. In one example, an inductor may include a cavity with diode, such as a low profile diode, that does not increase the area occupied by the inductor.

### CROSS-REFERENCE TO RELATED APPLICATIONS

The present Application for patent claims the benefit of U.S. Provisional Application No. 62/427,781, entitled “INDUCTOR WITH EMBEDDED DIODE”, filed Nov. 29, 2016, assigned to the assignee hereof, and expressly incorporated herein by reference in its entirety.

### FIELD OF DISCLOSURE

This disclosure relates generally to inductors and more specifically, but not exclusively, to inductors with embedded diodes.

### BACKGROUND

As more and more passive and active devices are implemented on printed circuit boards (PCBs), the spacing occupied by these components becomes critical. The more space a component occupies on a PCB, the less space available for other passive and active devices. For example, a PCB used in a mobile phone has many passive circuits and devices. The PCB, however, must remain small given the small enclosure of the mobile phone. In the case of a white light emitting diode backlight driver, the driver circuits and devices consume a lot of PCB area and make the PCB breakout of these devices and circuits challenging, especially for 0.35 mm pitch routing. Unfortunately, conventional drivers use large components and a lot of such components. The number and size of these components block breakout routes resulting in non-optimum usage of pins (e.g., double pins or pins breakout via inner layer of PCB) on the PCB.

Accordingly, there is a need for systems, apparatus, and methods that overcome the deficiencies of conventional approaches including the methods, system and apparatus provided hereby.

### SUMMARY

The following presents a simplified summary relating to one or more aspects and/or examples associated with the apparatus and methods disclosed herein. As such, the following summary should not be considered an extensive overview relating to all contemplated aspects and/or examples, nor should the following summary be regarded to identify key or critical elements relating to all contemplated aspects and/or examples or to delineate the scope associated with any particular aspect and/or example. Accordingly, the following summary has the sole purpose to present certain concepts relating to one or more aspects and/or examples relating to the apparatus and methods disclosed herein in a simplified form to precede the detailed description presented below.

In one aspect, an apparatus comprises an inductor with a cavity in a first side of the inductor and a diode located in the cavity.

Other features and advantages associated with the apparatus and methods disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 illustrates a bottom up view of an inductor with an embedded diode and capacitor in accordance with some examples of the disclosure.

FIG. 2 illustrates a side view along cut lines A-A′ of FIG. 1 in accordance with some examples of the disclosure.

FIG. 3 illustrates a side view along cut lines B-B′ of FIG. 1 in accordance with some examples of the disclosure.

FIG. 4 illustrates a bottom up view of an inductor with an embedded diode in accordance with some examples of the disclosure.

FIG. 5 illustrates a side view along cut lines C-C′ of FIG. 4 in accordance with some examples of the disclosure.

FIG. 6 illustrates a bottom up view of an inductor with an embedded diode and capacitor in accordance with some examples of the disclosure.

FIG. 7 illustrates a side view along cut lines D-D′ of FIG. 6 in accordance with some examples of the disclosure.

FIG. 8 illustrates a bottom up view of an inductor with an embedded diode and a capacitor along a side of the inductor in accordance with some examples of the disclosure.

FIG. 9 illustrates a side view along cut lines E-E′ of FIG. 8 in accordance with some examples of the disclosure.

FIG. 10 illustrates a side view along cut lines F-F′ of FIG. 8 in accordance with some examples of the disclosure.

FIG. 11 illustrates a bottom up view of an inductor with an embedded diode and capacitor in accordance with some examples of the disclosure.

FIG. 12 illustrates various electronic devices that may be integrated with any of the aforementioned integrated device, semiconductor device, integrated circuit, die, interposer, package or package-on-package (PoP) in accordance with some examples of the disclosure.

In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

The exemplary methods, apparatus, and systems disclosed herein mitigate shortcomings of the conventional methods, apparatus, and systems, as well as other previously unidentified needs.

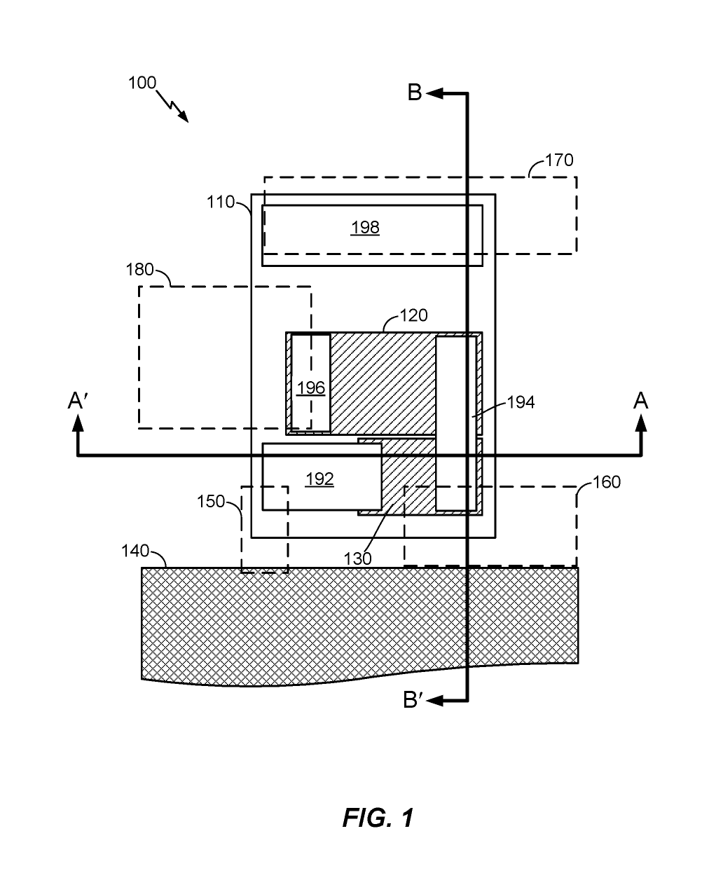

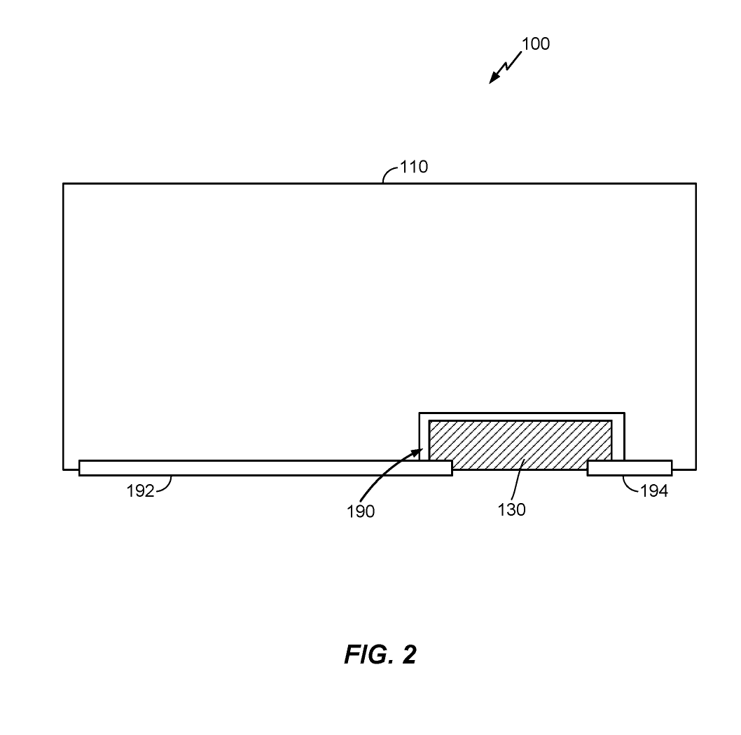

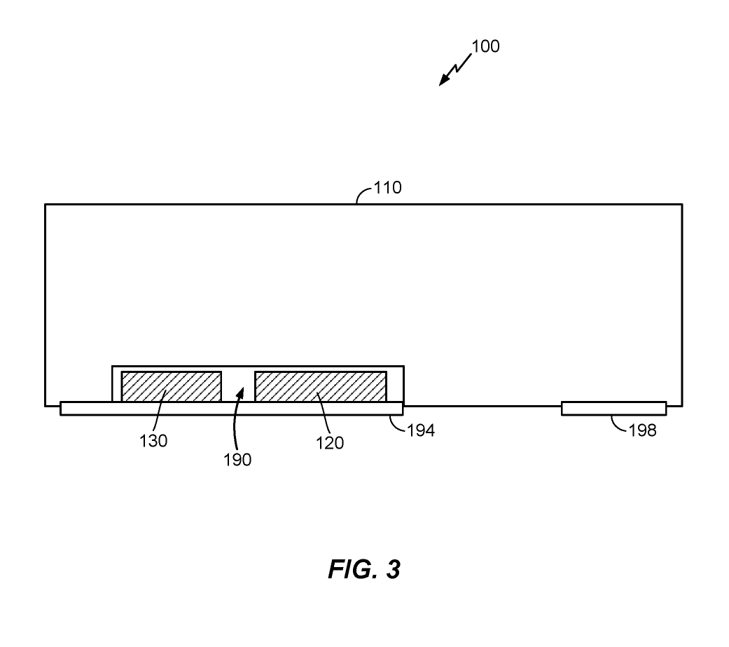

FIG. 1 illustrates a bottom up view of an inductor with an embedded diode and capacitor in accordance with some examples of the disclosure. As shown in FIG. 1, an inductive device 100 may include an inductor 110, a capacitor 120, a diode 130, an integrated circuit 140, a regulator switching node 150, a regulator output 160, an input voltage 170, a ground 180, a cavity 190 (shown in FIGS. 2 and 3) in a first side of the inductor 110, a first conductive pad 192, a second conductive pad 194, a third conductive pad 196, and a fourth conductive pad 198. The inductor 110 may be a solid core inductor or an inductor with a metal dust core. The inductor 110 may be a power inductor or a power choke coil. The inductor 110 may have a length of approximately 2.5 mm, a width of approximately 2.0 mm, and a height of approximately 0.8 mm. The inductor 110 may have a rating of approximately 4.7 μH to 10 μH. The diode 130 may be a schottky barrier diode. The diode 130 may have a length of approximately 1 mm, a width of approximately 0.6 mm, and a height of approximately 0.1 mm. The capacitor 120 may have a height of approximately 0.11 mm to 0.25 mm. The capacitor 120 may have a rating of approximately 0.1 μF to 2.2 μF. The integrated circuit 140 may be a power management integrated circuit. While not shown, it should be understood that the inductive device 100 may be mounted on a printed circuit board and may be integrated into a white light emitting diode backlight driver for a mobile phone, for example. In addition, the diode 130 and the capacitor 120 may be in a horizontal configuration relative to the inductor 110 such that the junctions (e.g., input/output connections) of the diode 130 and the capacitor 120 are to either side of the respective component instead of above and below the component (horizontal junctions versus vertical junctions). This horizontal configuration may allow the component to reduce the height of the cavity 190 necessary to accommodate the diode 130 and the capacitor 120 as well as the height of the diode 130 and the capacitor 120.

The input voltage 170 may be coupled to the fourth conductive pad 198 which in turn may be coupled to the inductor 110 for providing a voltage to the inductor 110. The ground 180 may be coupled to the third conductive pad 196 which in turn may be coupled to the capacitor 120 for providing a voltage potential to the capacitor 120. The regulator output 160 may be coupled to the integrated circuit 140 and the second conductive pad 194 which in turn may be coupled to the capacitor 120 and the diode 130 for providing a regulated voltage to the integrated circuit 140, the capacitor 120, and the diode 130. The regulator switching node 150 may be coupled to the integrated circuit 140 and the first conductive pad 192 which in turn may be coupled to the diode 130 for providing a switched voltage to the diode.

FIG. 2 illustrates a side view along cut lines A-A′ of FIG. 1 in accordance with some examples of the disclosure. As shown in FIG. 2, the inductive device 100 may include the inductor 110 with a cavity 190 on a first side of the inductor 110, the first conductive pad 192 coupled to the inductor 110 and the diode 130, the second conductive pad 194 coupled to the inductor 110 and the diode 130, and the diode 130 in the cavity 190 and having a surface of the diode 130 co-planar with the opening of the cavity 190. The cavity 190 may have a height of approximately 0.1 mm to 0.25 mm depending on the height of the diode 130 and or the capacitor 120, for example. The length and width of the cavity 190 may also be sized to accommodate the length and width of the diode 130 and or the capacitor 120, for example.

FIG. 3 illustrates a side view along cut lines B-B′ of FIG. 1 in accordance with some examples of the disclosure. As shown in FIG. 3, the inductive device 100 may include the inductor 110 with a cavity 190 on a first side of the inductor 110, the second conductive pad 194 coupled to the inductor 110 and the capacitor 120 and the diode 130, the fourth conductive pad 198 coupled to the inductor 110, the capacitor 120, and the diode 130 in the cavity 190 and having a surface of the diode 130 and a surface of the capacitor 120 co-planar with the opening of the cavity 190.

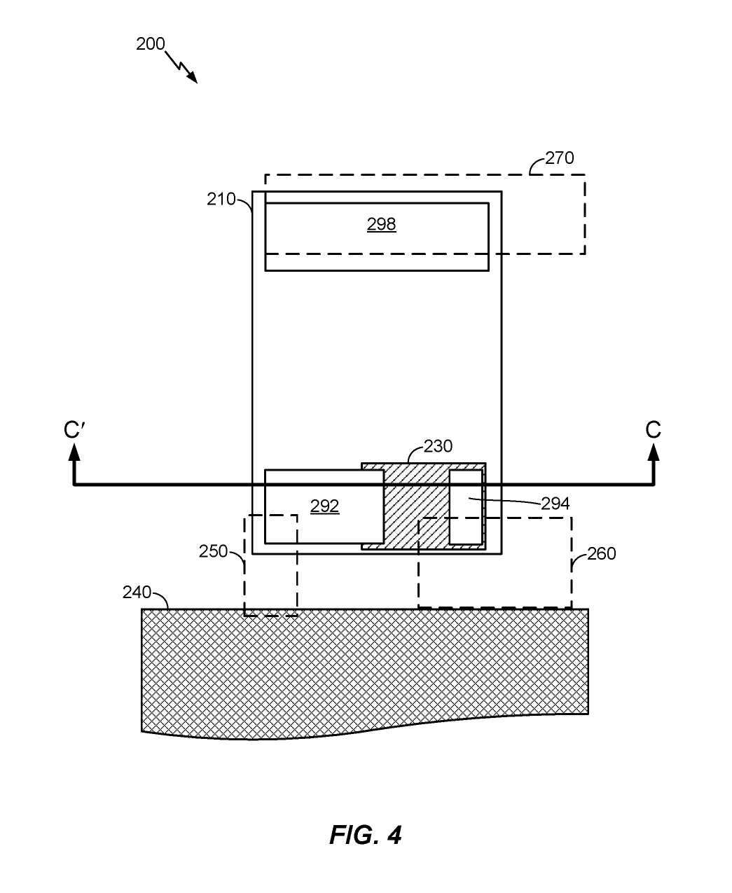

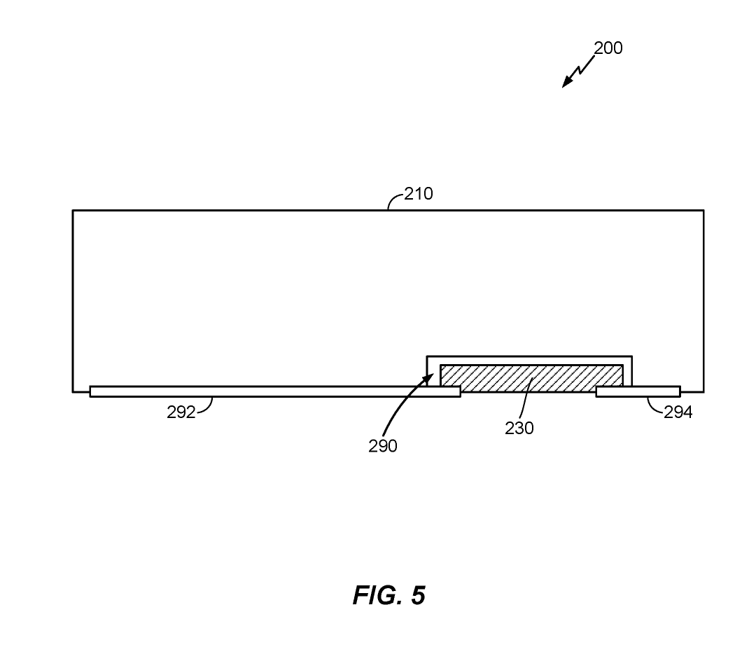

FIG. 4 illustrates a bottom up view of an inductor with an embedded diode in accordance with some examples of the disclosure. As shown in FIG. 4, an inductive device 200 may include an inductor 210, a diode 230, an integrated circuit 240, a regulator switching node 250, a regulator output 260, an input voltage 270, a cavity 290 (shown in FIG. 5) in a first side of the inductor 210, a first conductive pad 292, a second conductive pad 294, and a fourth conductive pad 298. The inductor 210 may be a solid core inductor or an inductor with a metal dust core. The inductor 210 may be a power inductor or a power choke coil. The inductor 210 may have a length of approximately 2.5 mm, a width of approximately 2.0 mm, and a height of approximately 0.8 mm. The inductor 210 may have a rating of approximately 4.7 μH to 10 μH. The diode 230 may be a schottky barrier diode. The diode 230 may have a length of approximately 1 mm, a width of approximately 0.6 mm, and a height of approximately 0.1 mm. The integrated circuit 240 may be a power management integrated circuit. While not shown, it should be understood that the inductive device 200 may be mounted on a printed circuit board and may be integrated into a white light emitting diode backlight driver for a mobile phone, for example. In addition, the diode 230 may be in a horizontal configuration relative to the inductor 210 such that the junctions (e.g., input/output connections) of the diode 230 are to either side of the component instead of above and below the component (horizontal junctions versus vertical junctions). This horizontal configuration may allow the component to reduce the height of the cavity 290 necessary to accommodate the diode 230 as well as the height of the diode 230.

The input voltage 270 may be coupled to the fourth conductive pad 298 which in turn may be coupled to the inductor 210 for providing a voltage to the inductor 210. The regulator output 260 may be coupled to the integrated circuit 240 and the second conductive pad 294 which in turn may be coupled to the diode 230 for providing a regulated voltage to the integrated circuit 240 and the diode 230. The regulator switching node 250 may be coupled to the integrated circuit 240 and the first conductive pad 292 which in turn may be coupled to the diode 230 for providing a switched voltage to the diode.

FIG. 5 illustrates a side view along cut lines C-C′ of FIG. 4 in accordance with some examples of the disclosure. As shown in FIG. 5, the inductive device 200 may include the inductor 210 with a cavity 290 on a first side of the inductor 210, the first conductive pad 292 coupled to the inductor 210 and the diode 230, the second conductive pad 294 coupled to the inductor 210 and the diode 230, and the diode 230 in the cavity 290. The cavity 290 may have a height of approximately 0.1 mm to 0.25 mm depending on the height of the diode 230, for example. The length and width of the cavity 290 may also be sized to accommodate the length and width of the diode 230, for example.

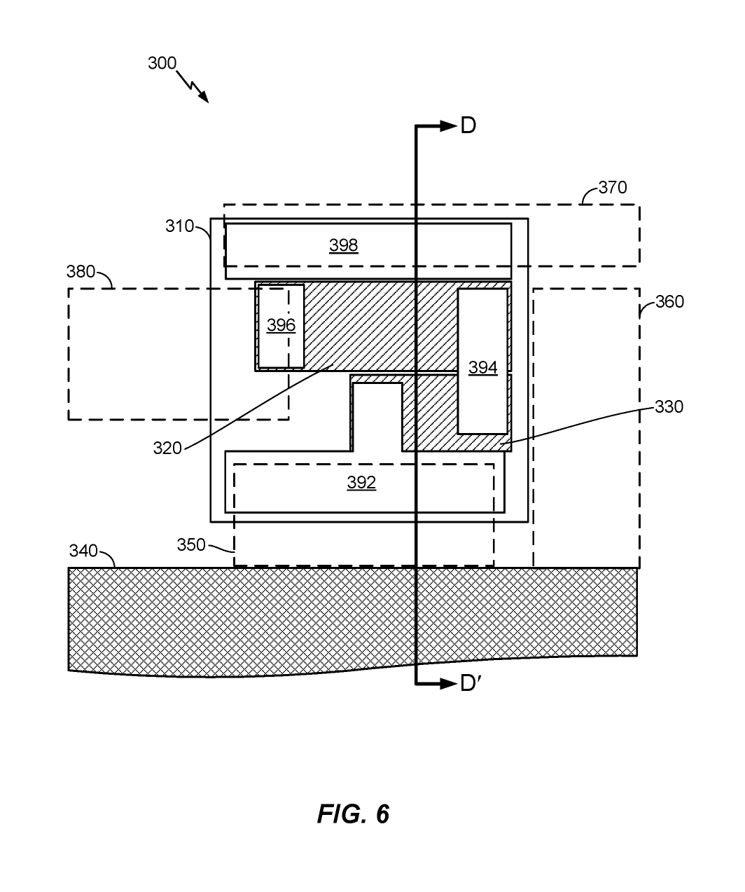

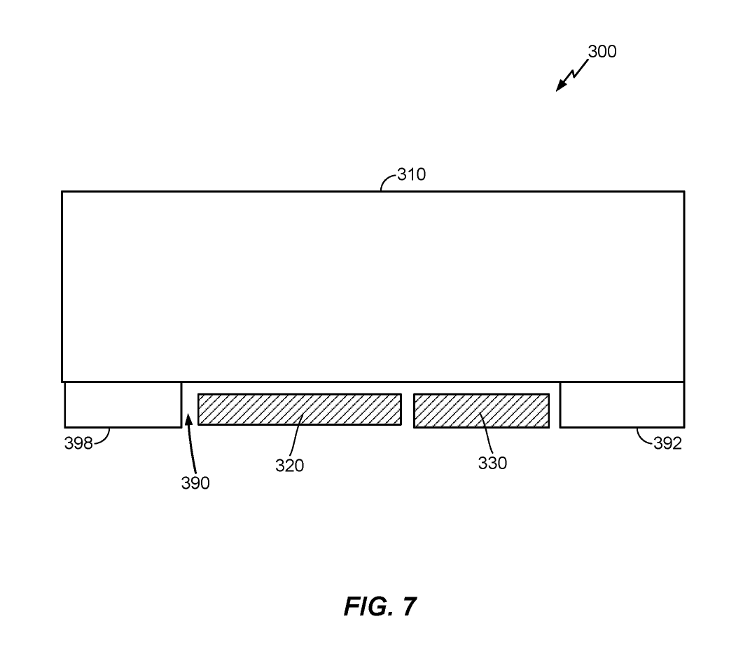

FIG. 6 illustrates a bottom up view of an inductor with an embedded diode and capacitor in accordance with some examples of the disclosure. As shown in FIG. 6, an inductive device 300 may include an inductor 310, a capacitor 320, a diode 330, an integrated circuit 340, a regulator switching node 350, a regulator output 360, an input voltage 370, a ground 380, a cavity 390 (shown in FIG. 7) in a first side of the inductor 310, a first conductive spacer 392, a first conductive pad 394, a second conductive pad 396, and a second conductive spacer 398. The first conductive pad 394 and the second conductive pad 396 may be of negligible height while the first conductive spacer 392 and the second conductive spacer 398 may be a non-negligible height sufficient to place a component, such as the capacitor 320 or the diode 330, under the inductor 310. The inductor 310 may be a solid core inductor or an inductor with a metal dust core. The inductor 310 may be a power inductor or a power choke coil. The inductor 310 may have a length of approximately 2.5 mm, a width of approximately 2.0 mm, and a height of approximately 0.8 mm. The inductor 310 may have a rating of approximately 4.7 μH to 10 μH. The diode 330 may be a schottky barrier diode. The diode 330 may have a length of approximately 1 mm, a width of approximately 0.6 mm, and a height of approximately 0.1 mm. The capacitor 320 may have a height of approximately 0.11 mm to 0.25 mm. The capacitor 320 may have a rating of approximately 0.1 μF to 2.2 μF. The integrated circuit 340 may be a power management integrated circuit. While not shown, it should be understood that the inductive device 300 may be mounted on a printed circuit board and may be integrated into a white light emitting diode backlight driver for a mobile phone, for example. In addition, the diode 330 and the capacitor 320 may be in a horizontal configuration relative to the inductor 310 such that the junctions (e.g., input/output connections) of the diode 330 and the capacitor 320 are to either side of the respective component instead of above and below the component (horizontal junctions versus vertical junctions). This horizontal configuration may allow the component to reduce the height of the cavity 390 necessary to accommodate the diode 330 and the capacitor 320 as well as the height of the diode 330 and the capacitor 320.

The input voltage 370 may be coupled to the second conductive spacer 398 which in turn may be coupled to the inductor 310 for providing a voltage to the inductor 310. The ground 380 may be coupled to the second conductive pad 396 which in turn may be coupled to the capacitor 320 for providing a voltage potential to the capacitor 320. The regulator output 360 may be coupled to the integrated circuit 340 and the first conductive pad 394 which in turn may be coupled to the capacitor 320 and the diode 330 for providing a regulated voltage to the integrated circuit 340, the capacitor 320, and the diode 330. The regulator switching node 350 may be coupled to the integrated circuit 340 and the first conductive spacer 392 which in turn may be coupled to the diode 330 for providing a switched voltage to the diode.

FIG. 7 illustrates a side view along cut lines D-D′ of FIG. 6 in accordance with some examples of the disclosure. As shown in FIG. 7, the inductive device 300 may include the inductor 310 with a cavity 390 on a first side of the inductor 310, the first conductive pad 394 coupled to the inductor 310 and the capacitor 320 and the diode 330, the second conductive spacer 398 coupled to the inductor 310, the capacitor 320, and the diode 330 in the cavity 390 and having a surface of the diode 330 and a surface of the capacitor 320 co-planar with the opening of the cavity 390.

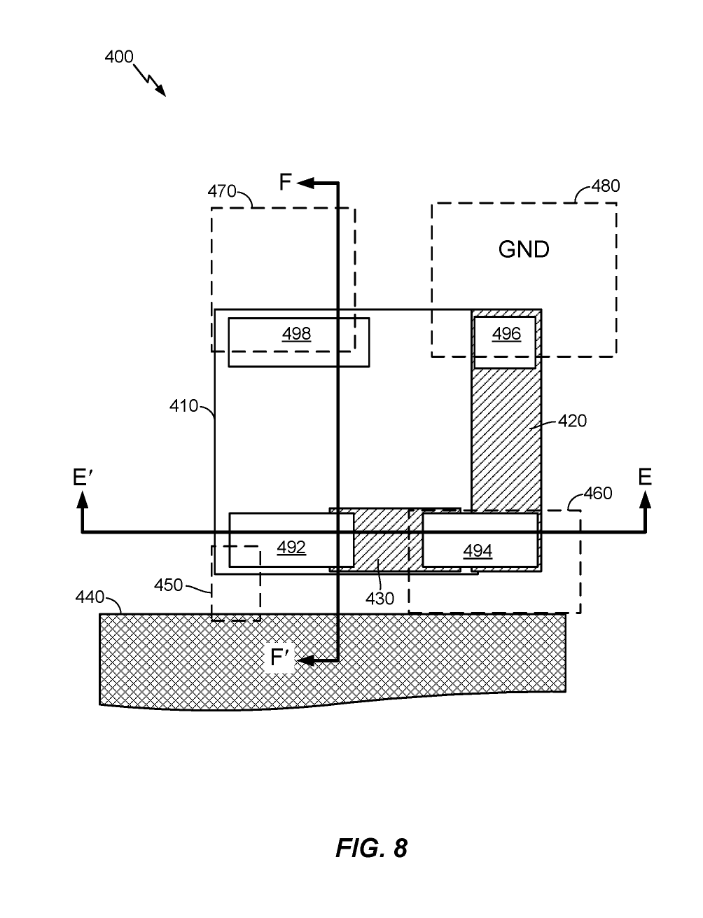

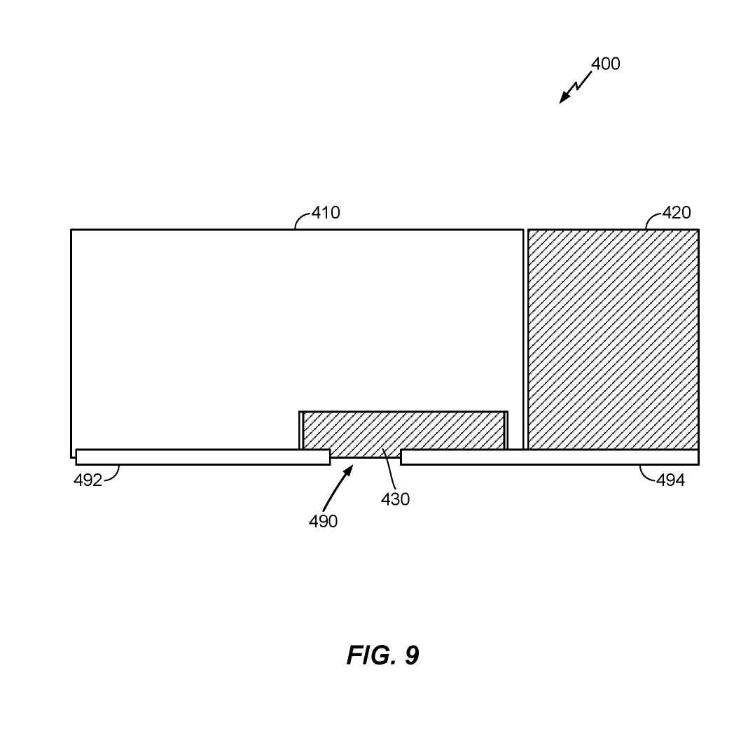

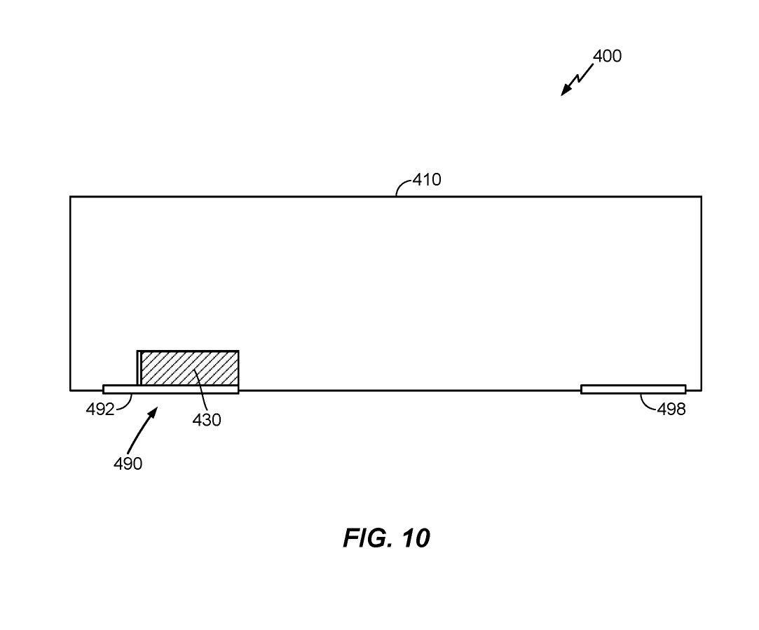

FIG. 8 illustrates a bottom up view of an inductor with an embedded diode and a capacitor along a side of the inductor in accordance with some examples of the disclosure. As shown in FIG. 8, an inductive device 400 may include an inductor 410, a capacitor 420 on a second side of inductor 410, a diode 430, an integrated circuit 440, a regulator switching node 450, a regulator output 460, an input voltage 470, a ground 480, a cavity 490 (shown in FIGS. 9 and 10) in a first side of the inductor 410, a first conductive pad 492, a second conductive pad 494, a third conductive pad 496, and a fourth conductive pad 498. The inductor 410 may be a solid core inductor or an inductor with a metal dust core. The inductor 410 may be a power inductor or a power choke coil. The inductor 410 may have a length of approximately 2.5 mm, a width of approximately 2.0 mm, and a height of approximately 0.8 mm. The inductor 410 may have a rating of approximately 4.7 μH to 10 μH. The diode 430 may be a schottky barrier diode. The diode 430 may have a length of approximately 1 mm, a width of approximately 0.6 mm, and a height of approximately 0.1 mm. The capacitor 420 may have a rating of approximately 0.1 μF to 2.2 μF. The integrated circuit 440 may be a power management integrated circuit. While not shown, it should be understood that the inductive device 400 may be mounted on a printed circuit board and may be integrated into a white light emitting diode backlight driver for a mobile phone, for example. In addition, the diode 430 may be in a horizontal configuration relative to the inductor 410 such that the junctions (e.g., input/output connections) of the diode 430 are to either side of the component instead of above and below the component (horizontal junctions versus vertical junctions). This horizontal configuration may allow the component to reduce the height of the cavity 490 necessary to accommodate the diode 430 as well as the height of the diode 430.

The input voltage 470 may be coupled to the fourth conductive pad 498 which in turn may be coupled to the inductor 410 for providing a voltage to the inductor 410. The ground 480 may be coupled to the third conductive pad 496 which in turn may be coupled to the capacitor 420 for providing a voltage potential to the capacitor 420. The regulator output 460 may be coupled to the integrated circuit 440 and the second conductive pad 494 which in turn may be coupled to the capacitor 420 and the diode 430 for providing a regulated voltage to the integrated circuit 440, the capacitor 420, and the diode 430. The regulator switching node 450 may be coupled to the integrated circuit 440 and the first conductive pad 492 which in turn may be coupled to the diode 430 for providing a switched voltage to the diode 430.

FIG. 9 illustrates a side view along cut lines E-E′ of FIG. 8 in accordance with some examples of the disclosure. As shown in FIG. 9, the inductive device 400 may include the inductor 410 with a cavity 490 on a first side of the inductor 410, the first conductive pad 492 coupled to the inductor 410 and the diode 430, the second conductive pad 494 coupled to the inductor 410 and the diode 430, the capacitor 420 on the second side of the inductor 410, and the diode 430 in the cavity 490 and having a surface of the diode 430 co-planar with the opening of the cavity 490. The cavity 490 may have a height of approximately 0.1 mm to 0.25 mm depending on the height of the diode 430, for example. The length and width of the cavity 490 may also be sized to accommodate the length and width of the diode 430, for example.

FIG. 10 illustrates a side view along cut lines F-F′ of FIG. 8 in accordance with some examples of the disclosure. As shown in FIG. 10, the inductive device 400 may include the inductor 410 with a cavity 490 on a first side of the inductor 410, the first conductive pad 492 coupled to the inductor 410 and the diode 430, the fourth conductive pad 498 coupled to the inductor 410, and the diode 430 in the cavity 490 and having a surface of the diode 430 co-planar with the opening of the cavity 490.

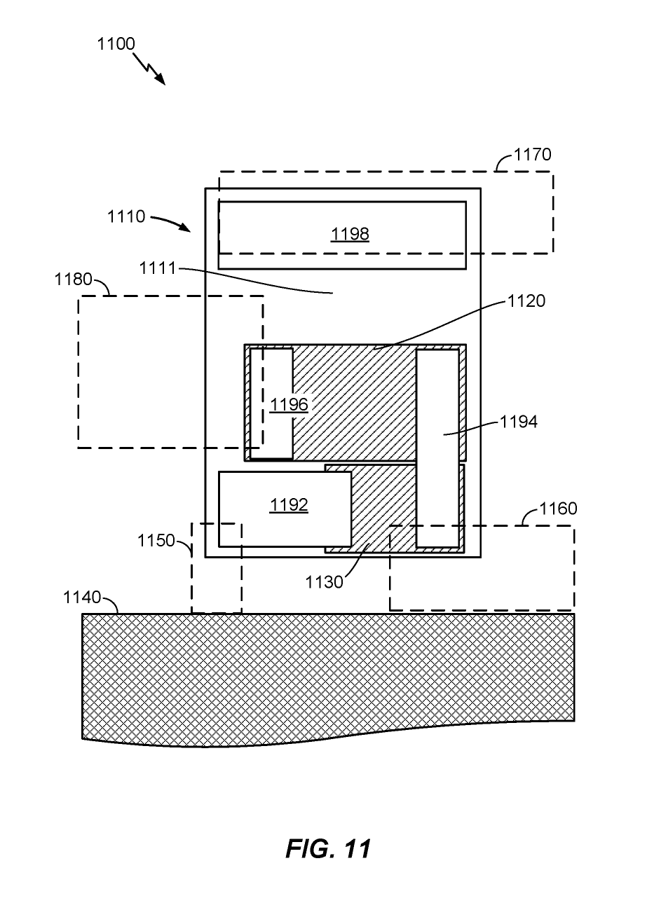

FIG. 11 illustrates a bottom up view of an inductor with an embedded diode and capacitor in accordance with some examples of the disclosure. As discussed previously, passive components and circuits implemented on printed circuit boards (PCBs) occupy a significant amount of space. This presents a problem as the number of these components required increases and less space is available for such passive components and circuits. For example, a PCB used in a mobile phone has many passive circuits and devices. The PCB, however, must remain small given the small enclosure of the mobile phone. In the specific case of a white light emitting diode backlight driver, the driver circuits and devices consume a lot of PCB area and make the PCB routing breakout of these devices and circuits challenging, especially for 0.35 mm pitch routing. In essence, external passive components, such as inductors, capacitors, and diodes, for white light emitting diode backlight drivers have the following problems: the passive components use up too much PCB area, make PCB routing breakouts for these components challenging, these large components and high count block breakout routes resulting in non-optimum usage of pins (e.g., double pins or pins breakout via an inner layer of the PCB). These problems may be solved by combining several discrete passive components into one footprint on the PCB that would otherwise be occupied by a single one of these components. The inductive device 1100 provides an example of this solution to the problem of the conventional approaches.

As shown in FIG. 11, an inductive device 1100 may include a means for storing energy in a magnetic field 1110 (e.g., inductor 110, inductor 210, inductor 310, and inductor 410) that includes a means for enhancing a magnetic field 1111 (e.g., a core of any of inductor 110, inductor 210, inductor 310, and inductor 410), a means for storing energy in an electrical field 1120 (e.g., capacitor 120, capacitor 320, and capacitor 420), a means for conducting electrical current in one direction 1130 (e.g., diode 130, diode 230, diode 330, and diode 430), an integrated circuit 1140, a regulator switching node 1150, a regulator output 1160, an input voltage 1170, a ground 1180, a cavity 1190 (not shown but see for example cavity 190 of FIGS. 2 and 3) in a first side of the means for enhancing a magnetic field 1111 of the means for storing energy in a magnetic field 1110, a first conductive pad 1192, a second conductive pad 1194, a third conductive pad 1196, and a fourth conductive pad 1198. The means for enhancing a magnetic field 1111 may be a solid core or a metal dust core. The means for storing energy in a magnetic field 1110 may be a power inductor or a power choke coil. The means for storing energy in a magnetic field 1110 may have a length of approximately 2.5 mm, a width of approximately 2.0 mm, and a height of approximately 0.8 mm. The means for storing energy in a magnetic field 1110 may have a rating of approximately 4.7 μH to 10 μH. The means for conducting electrical current in one direction 1130 may be a schottky barrier diode. The means for conducting electrical current in one direction 1130 may have a length of approximately 1 mm, a width of approximately 0.6 mm, and a height of approximately 0.1 mm. The means for storing energy in an electrical field 1120 may have a height of approximately 0.11 mm to 0.25 mm. The means for storing energy in an electrical field 1120 may have a rating of approximately 0.1 μF to 2.2 μF. The integrated circuit 1140 may be a power management integrated circuit. While not shown, it should be understood that the inductive device 1100 may be mounted on a printed circuit board and may be integrated into a white light emitting diode backlight driver for a mobile phone, for example. In addition, the means for conducting electrical current in one direction 1130 and the means for storing energy in an electrical field 1120 may be in a horizontal configuration relative to the means for storing energy in a magnetic field 1110 such that the junctions (e.g., input/output connections) of the means for conducting electrical current in one direction 1130 and the means for storing energy in an electrical field 1120 are to either side of the respective component instead of above and below the component (horizontal junctions versus vertical junctions). This horizontal configuration may allow the component to reduce the height of the cavity 1190 necessary to accommodate the means for conducting electrical current in one direction 1130 and the means for storing energy in an electrical field 1120 as well as the height of the means for conducting electrical current in one direction 1130 and the means for storing energy in an electrical field 1120.

The input voltage 1170 may be coupled to the fourth conductive pad 1198 which in turn may be coupled to the means for storing energy in a magnetic field 1110 for providing a voltage to the means for storing energy in a magnetic field 1110. The ground 1180 may be coupled to the third conductive pad 1196 which in turn may be coupled to the means for storing energy in an electrical field 1120 for providing a voltage potential to the means for storing energy in an electrical field 1120. The regulator output 1160 may be coupled to the integrated circuit 1140 and the second conductive pad 1194 which in turn may be coupled to the means for storing energy in an electrical field 1120 and the means for conducting electrical current in one direction 1130 for providing a regulated voltage to the integrated circuit 1140, the means for storing energy in an electrical field 1120, and the means for conducting electrical current in one direction 1130. The regulator switching node 1150 may be coupled to the integrated circuit 1140 and the first conductive pad 1192 which in turn may be coupled to the means for conducting electrical current in one direction 1130 for providing a switched voltage to the diode.

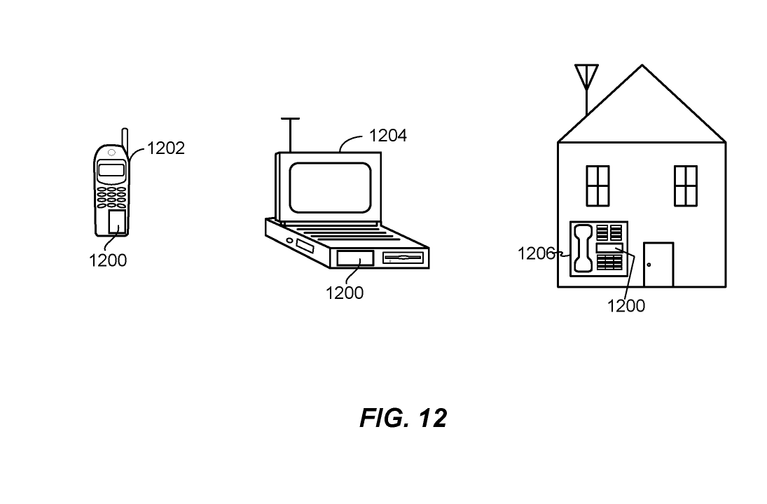

FIG. 12 illustrates various electronic devices that may be integrated with any of the aforementioned integrated device, semiconductor device, integrated circuit, die, interposer, package or package-on-package (PoP) in accordance with some examples of the disclosure. For example, a mobile phone device 1202, a laptop computer device 1204, and a fixed location terminal device 1206 may include an integrated device 1200 as described herein. The integrated device 1200 may be, for example, any of the integrated circuits, dies, integrated devices, integrated device packages, integrated circuit devices, device packages, integrated circuit (IC) packages, package-on-package devices described herein. The devices 1202, 1204, 1206 illustrated in FIG. 12 are merely exemplary. Other electronic devices may also feature the integrated device 1200 including, but not limited to, a group of devices (e.g., electronic devices) that includes mobile devices, hand-held personal communication systems (PCS) units, portable data units such as personal digital assistants, global positioning system (GPS) enabled devices, navigation devices, set top boxes, music players, video players, entertainment units, fixed location data units such as meter reading equipment, communications devices, smartphones, tablet computers, computers, wearable devices, servers, routers, electronic devices implemented in automotive vehicles (e.g., autonomous vehicles), or any other device that stores or retrieves data or computer instructions, or any combination thereof.

In this description, certain terminology is used to describe certain features. The term “mobile device” can describe, and is not limited to, a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, an automotive device in an automotive vehicle, and/or other types of portable electronic devices typically carried by a person and/or having communication capabilities (e.g., wireless, cellular, infrared, short-range radio, etc.). Further, the terms “user equipment” (UE), “mobile terminal,” “mobile device,” and “wireless device,” can be interchangeable.

One or more of the components, processes, features, and/or functions illustrated in FIGS. 1-12 may be rearranged and/or combined into a single component, process, feature or function or embodied in several components, processes, or functions. Additional elements, components, processes, and/or functions may also be added without departing from the disclosure. It should also be noted that FIGS. 1-12 and its corresponding description in the present disclosure is not limited to dies and/or ICs. In some implementations, FIGS. 1-12 and its corresponding description may be used to manufacture, create, provide, and/or produce integrated devices. In some implementations, a device may include a die, an integrated device, a die package, an integrated circuit (IC), a device package, an integrated circuit (IC) package, a wafer, a semiconductor device, a package on package (PoP) device, and/or an interposer.

The wireless communication between electronic devices can be based on different technologies, such as code division multiple access (CDMA), W-CDMA, time division multiple access (TDMA), frequency division multiple access (FDMA), Orthogonal Frequency Division Multiplexing (OFDM), Global System for Mobile Communications (GSM), 3GPP Long Term Evolution (LTE) or other protocols that may be used in a wireless communications network or a data communications network.

The word “exemplary” is used herein to mean “serving as an example, instance, or illustration.” Any details described herein as “exemplary” is not to be construed as advantageous over other examples. Likewise, the term “examples” does not mean that all examples include the discussed feature, advantage or mode of operation. Furthermore, a particular feature and/or structure can be combined with one or more other features and/or structures. Moreover, at least a portion of the apparatus described hereby can be configured to perform at least a portion of a method described hereby.

The terminology used herein is for the purpose of describing particular examples and is not intended to be limiting of examples of the disclosure. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, actions, operations, elements, and/or components, but do not preclude the presence or addition of one or more other features, integers, actions, operations, elements, components, and/or groups thereof.

It should be noted that the terms “connected,” “coupled,” or any variant thereof, mean any connection or coupling, either direct or indirect, between elements, and can encompass a presence of an intermediate element between two elements that are “connected” or “coupled” together via the intermediate element.

Any reference herein to an element using a designation such as “first,” “second,” and so forth does not limit the quantity and/or order of those elements. Rather, these designations are used as a convenient method of distinguishing between two or more elements and/or instances of an element. Also, unless stated otherwise, a set of elements can comprise one or more elements.

Nothing stated or illustrated depicted in this application is intended to dedicate any component, action, feature, benefit, advantage, or equivalent to the public, regardless of whether the component, action, feature, benefit, advantage, or the equivalent is recited in the claims.

Further, those of skill in the art will appreciate that the various illustrative logical blocks, modules, circuits, and algorithm actions described in connection with the examples disclosed herein may be implemented as electronic hardware, computer software, or combinations of both. To clearly illustrate this interchangeability of hardware and software, various illustrative components, blocks, modules, circuits, and actions have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Although some aspects have been described in connection with a device, it goes without saying that these aspects also constitute a description of the corresponding method, and so a block or a component of a device should also be understood as a corresponding method action or as a feature of a method action. Analogously thereto, aspects described in connection with or as a method action also constitute a description of a corresponding block or detail or feature of a corresponding device. Some or all of the method actions can be performed by a hardware apparatus (or using a hardware apparatus), such as, for example, a microprocessor, a programmable computer or an electronic circuit. In some examples, some or a plurality of the most important method actions can be performed by such an apparatus.

In the detailed description above it can be seen that different features are grouped together in examples. This manner of disclosure should not be understood as an intention that the claimed examples have more features than are explicitly mentioned in the respective claim. Rather, the situation is such that inventive content may reside in fewer than all features of an individual example disclosed. Therefore, the following claims should hereby be deemed to be incorporated in the description, wherein each claim by itself can stand as a separate example. Although each claim by itself can stand as a separate example, it should be noted that—although a dependent claim can refer in the claims to a specific combination with one or a plurality of claims—other examples can also encompass or include a combination of said dependent claim with the subject matter of any other dependent claim or a combination of any feature with other dependent and independent claims. Such combinations are proposed herein, unless it is explicitly expressed that a specific combination is not intended. Furthermore, it is also intended that features of a claim can be included in any other independent claim, even if said claim is not directly dependent on the independent claim.

It should furthermore be noted that methods, systems, and apparatus disclosed in the description or in the claims can be implemented by a device comprising means for performing the respective actions of this method.

Furthermore, in some examples, an individual action can be subdivided into a plurality of sub-actions or contain a plurality of sub-actions. Such sub-actions can be contained in the disclosure of the individual action and be part of the disclosure of the individual action.

While the foregoing disclosure shows illustrative examples of the disclosure, it should be noted that various changes and modifications could be made herein without departing from the scope of the disclosure as defined by the appended claims. The functions and/or actions of the method claims in accordance with the examples of the disclosure described herein need not be performed in any particular order. Additionally, well-known elements will not be described in detail or may be omitted so as to not obscure the relevant details of the aspects and examples disclosed herein. Furthermore, although elements of the disclosure may be described or claimed in the singular, the plural is contemplated unless limitation to the singular is explicitly stated.

What is claimed is:

1. An apparatus comprising:
an inductor with a cavity in a first side of the inductor; and
an electrical component located in the cavity, a surface of the electrical component co-planar with an opening of the cavity.

2. The apparatus of claim 1, wherein the electrical component is one of a diode or a capacitor.

3. The apparatus of claim 1, further comprising a plurality of conductive pads on the first side of the inductor.

4. The apparatus of claim 1, wherein the inductor has a solid core.

5. The apparatus of claim 1, further comprising a capacitor proximate to the inductor outside the cavity.

6. The apparatus of claim 5, wherein the capacitor is located in the cavity with a surface of the capacitor co-planar with an opening in the cavity.

7. The apparatus of claim 1, further comprising a power management integrated circuit proximate to the inductor.

8. The apparatus of claim 1, further comprising a ground, a regulator output and a regulator switching node.

9. The apparatus of claim 8, further comprising a first conductive pad coupled to the ground, a second conductive pad coupled to the regulator output, a third conductive pad coupled to the regulator switching node, and a fourth conductive pad coupled to an input voltage.

10. The apparatus of claim 1, wherein the apparatus is incorporated into a device selected from the group consisting of a white light emitting diode backlight driver, a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.

11. An apparatus comprising:
an inductor with a cavity in a first side of the inductor; and
a first electrical component located in the cavity, a surface of the first electrical component co-planar with an opening of the cavity; and
a second electrical component located in the cavity, a surface of the second electrical component co-planar with the opening of the cavity.

12. The apparatus of claim 11, wherein the first electrical component is a diode and the second electrical component is a capacitor.

13. The apparatus of claim 11, further comprising a plurality of conductive pads on the first side of the inductor.

14. The apparatus of claim 11, further comprising a power management integrated circuit proximate to the inductor.

15. The apparatus of claim 11, wherein the inductor has a solid core.

16. The apparatus of claim 11, further comprising a ground, a regulator output and a regulator switching node.

17. The apparatus of claim 16, further comprising a first conductive pad coupled to the ground, a second conductive pad coupled to the regulator output, a third conductive pad coupled to the regulator switching node, and a fourth conductive pad coupled to an input voltage.

18. The apparatus of claim 11, wherein the apparatus is incorporated into a device selected from the group consisting of a white light emitting diode backlight driver, a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.

19. An apparatus comprising:
means for storing energy in a magnetic field with a cavity in a first side of the means for storing energy in the magnetic field; and
means for conducting electrical current in one direction located in the cavity, a surface of the means for conducting electrical current in one direction co-planar with an opening of the cavity.

20. The apparatus of claim 19, wherein the means for conducting electrical current in one direction is a diode.

21. The apparatus of claim 19, further comprising means for storing energy in an electrical field located in the cavity with a surface of the means for storing energy in the electrical field co-planar with the opening in the cavity.

22. The apparatus of claim 19, wherein the means for storing energy in the magnetic field has a solid core.

23. The apparatus of claim 19, further comprising a ground, a regulator output and a regulator switching node.

24. The apparatus of claim 23, further comprising a first conductive pad coupled to the ground, a second conductive pad coupled to the regulator output, a third conductive pad coupled to the regulator switching node, and a fourth conductive pad coupled to an input voltage.

25. The apparatus of claim 19, wherein the apparatus is incorporated into a device selected from the group consisting of a white light emitting diode backlight driver, a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.

26. An apparatus comprising:
means for storing energy in a magnetic field with a cavity in a first side of the means for storing energy in the magnetic field;
means for conducting electrical current in one direction located in the cavity, a surface of the means for conducting electrical current in one direction co-planar with an opening of the cavity; and
means for storing energy in an electrical field, a surface of the means for storing energy in the electrical field co-planar with the opening in the cavity.

27. The apparatus of claim 26, wherein the means for conducting electrical current in one direction is a diode and the means for storing energy in an electrical field is a capacitor.

28. The apparatus of claim 26, wherein the means for storing energy in the magnetic field has a solid core.

29. The apparatus of claim 26, further comprising a first conductive pad coupled to a ground, a second conductive pad coupled to a regulator output, a third conductive pad coupled to a regulator switching node, and a fourth conductive pad coupled to an input voltage.

30. The apparatus of claim 26, wherein the apparatus is incorporated into a device selected from the group consisting of a white light emitting diode backlight driver, a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.
